(19) United States
(12) Patent Application Publication
(10) Pub. No.: US 2021/0349433 A1
(43) Pub. Date: Nov. 11, 2021

(54) SYSTEM AND METHOD FOR MODIFYING AN INITIAL POLICY OF AN INPUT/OUTPUT DEVICE

(71) Applicant: Intuition Robotics, Ltd., Ramat-Gan (IL)

(72) Inventors: Shay ZWEIG, Harel (IL); Alex KEAGEL, Tel Aviv (IL); Itai MENDELSOHN, Tel Aviv (IL); Roy AMIR, Mikhmoret (IL); Dor SKULER, Oranit (IL); Eldar RON, Tel Aviv (IL)

(73) Assignee: Intuition Robotics, Ltd., Ramat-Gan (IL)

(21) Appl. No.: 17/316,963

(22) Filed: May 11, 2021

Related U.S. Application Data
(60) Provisional application No. 63/022,939, filed on May 11, 2020.

(51) Int. Cl. G05B 19/042; G06N 20/00; G06K 9/62

(52) U.S. Cl. CPC G05B 19/0423; G06N 20/00; G05B 2219/21007; G05B 2219/21003; G06K 9/6262

(57) ABSTRACT

A system and method for modifying an initial policy of an input/output device are provided. The method includes receiving, by an input/output (I/O) device, an input from a user device, wherein the input comprises an initial policy of the I/O device; collecting, by the I/O device, a first set of real-time data related to an environment in proximity of a user interacting with the I/O device; applying a machine learning model on the collected first set of real-time data to determine a current state in proximity to the user; executing a plan based on the determined current state and the initial policy received from the user device, wherein the initial policy facilitates execution of at least one plan by the I/O device; collecting, by the I/O device, a feedback data feature with respect to the executed plan, wherein the feedback data feature relates to how the user responds to the executed plan; applying a machine learning model on the collected feedback data feature to determine if the initial policy should be modified; and modifying the initial policy of the I/O device when it is determined that the initial policy should be modified based the collected feedback data feature.

### CROSS-REFERENCE TO RELATED APPLICATIONS

This application claims the benefit of U.S. Provisional Application No. 63/022,939 filed on May 11, 2020, the contents of which are hereby incorporated by reference.

### TECHNICAL FIELD

The disclosure generally relates to input/output devices, such as digital assistants, and more specifically to a system and method for modifying an initial policy of an input/output device.

### BACKGROUND

As manufacturers continue to improve electronic device functionality through the inclusion of processing hardware, users, as well as manufacturers themselves, may desire expanded feature sets to enhance the utility of the included hardware. Examples of technologies which have been improved, in recent years, by the addition of faster, more-powerful processing hardware include cell phones, personal computers, vehicles, and the like. As described, such devices have also been updated to include software functionalities which provide for enhanced user experiences by leveraging device connectivity, increases in processing power, and other functional additions to such devices. However, the software solutions described, while including some features relevant to some users, may fail to provide certain features which may further enhance the quality of a user experience.

Many modern devices, such as cell phones, computers, vehicles, and the like, include software suites which leverage device hardware to provide enhanced user experiences. Examples of such software suites include cell phone virtual assistants, which may be activated by voice command to perform tasks such as playing music, starting a phone call, and the like, as well as in-vehicle virtual assistants configured to provide similar functionalities. While such software suites may provide for enhancement of certain user interactions with a device, such as by allowing a user to place a phone call using a voice command, the same suites may fail to provide adaptive, customized functionalities, thereby hindering the user experience. As certain currently-available user experience software suites for electronic devices may fail to provide adaptive, customized functionalities, the same suites may be unable to learn, and adapt to, a user's preferences, thereby requiring a user to engage with non-preferred or non-ideal software suite executions across multiple instances, which may limit user experience quality.

Further, in addition to failing to provide adaptive, customized functionalities, the same user experience software suites for electronic devices may fail to include context-aware functionalities. Where such suites lack context-aware functionalities, the same suites may be unable to identify data concerning a user's environment, such as whether a user is riding in a vehicle with another passenger, as well as data concerning a user's preferences, such as whether a user enjoys or does not enjoy a particular podcast. Where electronic device user experience software suites fail to provide for context awareness and user preference detection, the same suites may fail to tailor the execution of software features to a user's preference or environment, thereby limiting the applicability of such software, as well as a user's enjoyment of an electronic device including such software.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for modifying an initial policy of an input/output device. The method comprises: receiving, by an input/output (I/O) device, an input from a user device, wherein the input comprises an initial policy of the I/O device; collecting, by the I/O device, a first set of real-time data related to an environment in proximity of a user interacting with the I/O device; applying a first machine learning model on the collected first set of real-time data to determine a current state in proximity to the user; executing a plan based on the determined current state and the initial policy received from the user device, wherein the initial policy facilitates execution of at least one plan by the I/O device; collecting, by the I/O device, a feedback data feature with respect to the executed plan, wherein the feedback data feature relates to how the user responds to the executed plan; applying a second machine learning model on the collected feedback data feature to determine if the initial policy should be modified; and modifying the initial policy of the I/O device when it is determined that the initial policy should be modified based the collected feedback data feature.

Certain embodiments disclosed herein also include a non-transitory computer readable medium having stored thereon instructions for causing a processing circuitry to execute a process, the process comprising: receiving, by an input/output (I/O) device, an input from a user device, wherein the input comprises an initial policy of the I/O device; collecting, by the I/O device, a first set of real-time data related to an environment in proximity of a user interacting with the I/O device; applying a first machine learning model on the collected first set of real-time data to determine a current state in proximity to the user; executing a plan based on the determined current state and the initial policy received from the user device, wherein the initial policy facilitates execution of at least one plan by the I/O device; collecting, by the I/O device, a feedback data feature with respect to the executed plan, wherein the feedback data feature relates to how the user responds to the executed plan; applying a second machine learning model on the collected feedback data feature to determine if the initial policy should be modified; and modifying the initial policy of the I/O device when it is determined that the initial policy should be modified based the collected feedback data feature.

Certain embodiments disclosed herein also include a system for modifying an initial policy of an input/output device. The system comprises: a processing circuitry; and a memory, the memory containing instructions that, when executed by the processing circuitry, configure the system to: receive, by an input/output (I/O) device, an input from a user device, wherein the input comprises an initial policy of the I/O device; collect, by the I/O device, a first set of real-time data related to an environment in proximity of a user interacting with the I/O device; apply a first machine learning model on the collected first set of real-time data to determine a current state in proximity to the user; execute a plan based on the determined current state and the initial policy received from the user device, wherein the initial policy facilitates execution of at least one plan by the I/O device; collect, by the I/O device, a feedback data feature with respect to the executed plan, wherein the feedback data feature relates to how the user responds to the executed plan; apply a second machine learning model on the collected feedback data feature to determine if the initial policy should be modified; and modify the initial policy of the I/O device when it is determined that the initial policy should be modified based the collected feedback data feature.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a system utilized for modifying an initial policy of an input/output (I/O) device, according to an embodiment.

FIG. 2 is a block diagram of a controller integrated in the I/O device, according to an embodiment.

FIG. 3 is a flowchart illustrating a method for modifying an initial policy of an I/O device of a digital assistant, according to an embodiment.

FIG. 4 is a flowchart illustrating a method for executing a plan by an I/O device of a digital assistant based on a modified initial policy of the I/O device of the digital assistant, according to an embodiment.

### DETAILED DESCRIPTION

The embodiments disclosed by the disclosure are only examples of the many possible advantageous uses and implementations of the innovative teachings presented herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality. In the drawings, like numerals refer to like parts through several views.

An initial policy of an I/O device, such as may be integrated in a digital assistant that facilitates execution of at least one plan by the digital assistant, is received by the digital assistant. Feedback data is collected from a user of the digital assistant with respect to a plan that has been executed by the digital assistant based on the initial policy and a set of real-time data regarding the user. The initial policy of the digital assistant is then modified based on the collected feedback data. Then, real-time data about the user and the environment near the user is collected and analyzed. Upon determination that execution of a plan by the digital assistant is desirable, the plan is executed by the digital assistant using the modified initial policy.

With the system and method described herein, a digital assistant can automatically and constantly update the initial policy of the digital assistant, thereby allowing for adaptation of the initial policy to the user's preferences and patterns as these patterns and preferences are identified through time. Moreover, using the system and method described above, convergence of the learning (using data that has been collected about the user) becomes faster and more efficient.

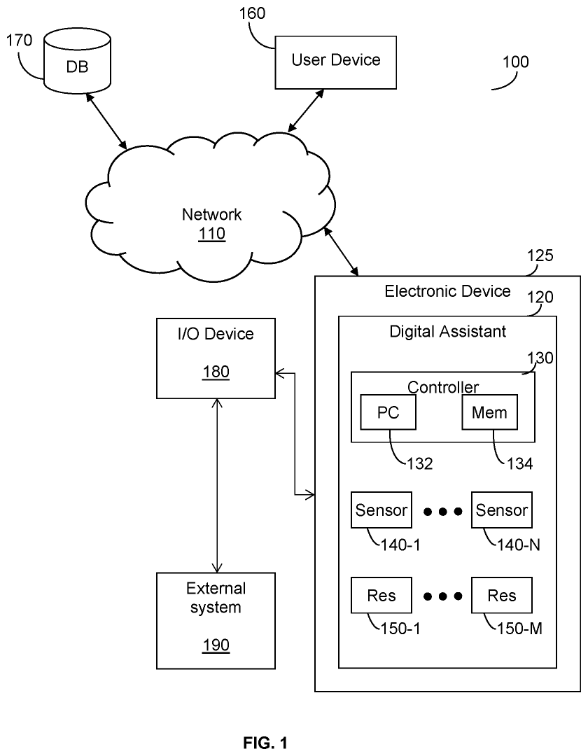

FIG. 1 is an example network diagram of a system 100 utilized for modifying an initial policy of an input/output (I/O) device, according to an embodiment. The system 100 includes a digital assistant 120 and an electronic device 125, as well as an input/output (I/O) device 180 connected to the electronic device 125, and an external system 190 connected to the I/O device 180. In some embodiments, the digital assistant 120 is further connected to a network, where the network 110 is used to communicate between different parts of the system 100. The network 110 may be, but is not limited to, a local area network (LAN), a wide area network (WAN), a metro area network (MAN), the Internet, a wireless, cellular or wired network, and the like, and any combination thereof.

In an embodiment, the digital assistant 120 may be connected to, or implemented on, the electronic device 125. The electronic device 125 may be, for example and without limitation, a robot, a social robot, a service robot, a smart TV, a smartphone, a wearable device, a vehicle, a computer, a smart appliance, or the like.

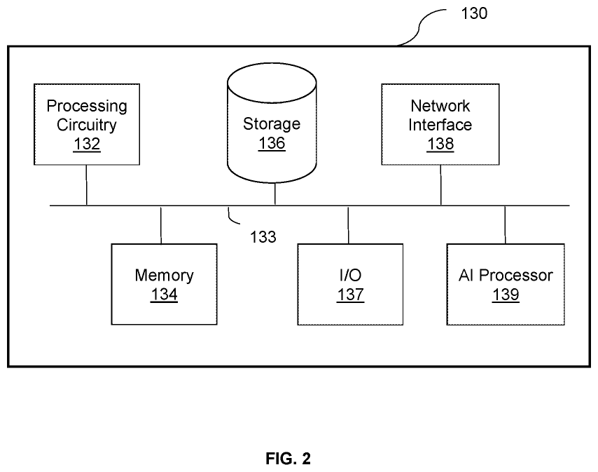

The digital assistant 120 includes a controller 130, explained in greater detail with respect to FIG. 2, below, having at least a processing circuitry 132 and a memory 134. The digital assistant 120 may further include, or be connected to, one or more sensors 140-1 to 140-N, where N is an integer equal to or greater than 1 (hereinafter, “sensor” 140 or “sensors” 140), and one or more resources 150-1 to 150-M, where M is an integer equal to or greater than 1 (hereinafter, “resource” 150 or “resources” 150). The resources 150 may include, for example and without limitation, electro-mechanical elements, display units, speakers, and the like, as well as any combination thereof. In an embodiment, the resources 150 may include sensors 140 as well.

The sensors 140 may include input devices, such as various sensors, detectors, microphones, touch sensors, movement detectors, cameras, and the like. Any of the sensors 140 may be, but are not necessarily, communicatively or otherwise connected to the controller 130 (such connection is not illustrated in FIG. 1 for sake of simplicity and without limitation on the disclosed embodiments). The sensors 140 may be configured to sense signals received from one or more users, the environment of the user (or users), and the like. The sensors 140 may be positioned on, or connected to, the electronic device 125 (e.g., a vehicle, a robot, and so on). In an embodiment, the sensors 140 may be implemented as virtual sensors that receive inputs from online services, e.g., the weather forecast, user's calendar, and the like.

In an embodiment, the system 100 further includes a user device 160. One or more user devices, such as the user device 160, may be communicatively connected to the digital assistant 120 over, for example, the network 110. A user device 160 may be, for example, a personal computer, a server, a smartphone, a laptop, or the like. The user device 160 may be used for sending inputs, data, electronic messages, and the like, to the digital assistant 120.

In one embodiment, the system 100 further includes a database 170. The database 170 may be stored within the digital assistant 120 (e.g., within a storage device not shown), or may be separate from the digital assistant 120 and connected thereto via the network 110. The database 170 may be utilized for storing, for example, data associated with one or more users, historical data about one or more users, digital assistant policies, and the like.

The I/O device 180 is a device configured to generate, transmit, receive, or the like, as well as any combination thereof, one or more signals relevant to the operation of the external system 190. In an embodiment, the I/O device 180 is further configured to at least cause one or more outputs in the outside world (i.e., the world outside the computing components shown in FIG. 1) via the external system 190 based on plans determined by the assistant 120 as described herein.

The I/O device 180 may be communicatively connected to the electronic device 125 and the external system 190. It may be understood that while the I/O device 180 is depicted as separate from the electronic device 125, it may be understood that the I/O device 180 may be included in the electronic device 125, or any component or sub-component thereof, without loss of generality or departure from the scope of the disclosure.

The external system 190 is a device, component, system, or the like, configured to provide one or more functionalities, including various interactions with external environments. The external system 190 is a system separate from the electronic device 125, although the external system 190 may be co-located with, and connected to, the electronic device 125, without loss of generality or departure from the scope of the disclosure. Examples of external systems 190 include, without limitation, air conditioning systems, lighting systems, sound systems, and the like.

FIG. 2 shows a schematic block diagram of a controller 130 integrated in the I/O device, according to an embodiment. The controller 130 includes a processing circuitry 132 that is configured to receive data, analyze data, generate outputs, and the like, as further described hereinbelow. The processing circuitry 132 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The controller 130 further includes a memory 134. The memory 134 may contain therein instructions that, when executed by the processing circuitry 132, cause the controller 130 to execute actions as further described hereinbelow. The memory 134 may further store therein information, e.g., data associated with one or more users, historical data about one or more users, digital assistant policies, and the like.

The storage 136 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

In an embodiment, the controller 130 includes a network interface 138 that is configured to connect to a network, e.g., the network 110 of FIG. 1. The network interface 138 may include, but is not limited to, a wired interface (e.g., an Ethernet port), or a wireless port (e.g., an 802.11 compliant Wi-Fi card), configured to connect to a network (not shown).

The controller 130 further includes an input/output (I/O) interface 137 configured to control the resources 150 (shown in FIG. 1) that are connected to the digital assistant 120. In an embodiment, the I/O interface 137 is configured to receive one or more signals captured by sensors 140 of the digital assistant 120 and send the signals to the processing circuitry 132 for analysis. According to one embodiment, the I/O interface 137 is configured to analyze the signals captured by the sensors 140, detectors, and the like. According to a further embodiment, the I/O interface 137 is configured to send one or more commands to one or more of the resources 150 for executing one or more plans (e.g., actions) of the digital assistant 120, as further discussed hereinbelow. A plan may include, for example, suggesting that a user to listen to Jazz music, suggesting initiation of a navigation plan to a specific address, initiating a navigation plan, and the like. According to a further embodiment, the components of the controller 130 are connected via a bus 133.

In an embodiment, the controller 130 further includes an artificial intelligence (AI) processor 139. The AI processor 139 may be realized as one or more hardware logic components and circuits, including graphics processing units (GPUs), tensor processing units (TPUs), neural processing units, vision processing units (VPUs), reconfigurable field-programmable gate arrays (FPGAs), and the like. The AI processor 139 is configured to perform, for example, machine learning, based on sensory inputs received from the I/O interface 137, which receives input data, such as sensory inputs, from the sensors 140.

In an embodiment, the controller 130 is configured to apply a machine learning model via the AI processor 139 to detect anomalies in user behavior. The machine learning model is trained based on historical user behavior data in order to learn baseline user behavior which can be utilized to identify and determine positive and negative responses to actions performed by the digital assistance. The machine learning model is also trained to determine current state in proximity to the user based on data collected in the close environment of the user. To this end, such a machine learning model is trained using a training data set including training data related to user actions in response to various external stimuli and, more specifically, external stimuli related to outputs caused by a digital assistant (e.g., the digital assistant 120, FIG. 1).

In an embodiment, the controller 130 receives an input from a user device (e.g., the user device 160). The input includes an initial policy of the digital assistant. The initial policy facilitates execution of at least one plan to be executed by the I/O device 180 of the digital assistant 120.

A plan may include an action or a series of actions that are executed by the digital assistant 120. A plan may be, for example, suggesting a certain type of music, initiating a navigation plan to a specific destination, and the like. The initial policy may include a set of initial guidelines that facilitates execution of at least one plan by the digital assistant 120. The initial policy may be entered by a user device (e.g., the user device 160) that is associated with a person, an expert, or the like. The initial policy (e.g., the initial guidelines) may include one or more behavioral rules of the digital assistant 120. The initial policy and the initial guidelines that are related thereto may facilitate execution of plans by the digital assistant 120 in circumstances where there is no data about the user yet, or when there is not enough data to determine which plan should be executed. In an embodiment, the initial policy and the guidelines that are related thereto may be used for determining the way a plan is executed in terms of tone, wording, action order, number of resources (e.g., the resources 150) used for executing the plan, and the like.

As an example, an input that includes an initial policy of the digital assistant 120 is received by the digital assistant 120 that operates in a vehicle. The initial policy determines that when the user is alone in the vehicle, that the vehicle is located on a highway and that heavy traffic is identified, a plan that suggests that the user listen to music should be generated. As another example, an input that includes an initial policy of the digital assistant 120 is received by the digital assistant 120 that operates as a social robot at the user's house. The initial policy includes a determination that, when the user is alone at home and watching television for more than two hours, a plan that suggests to the user to play a cognitive game should be generated.

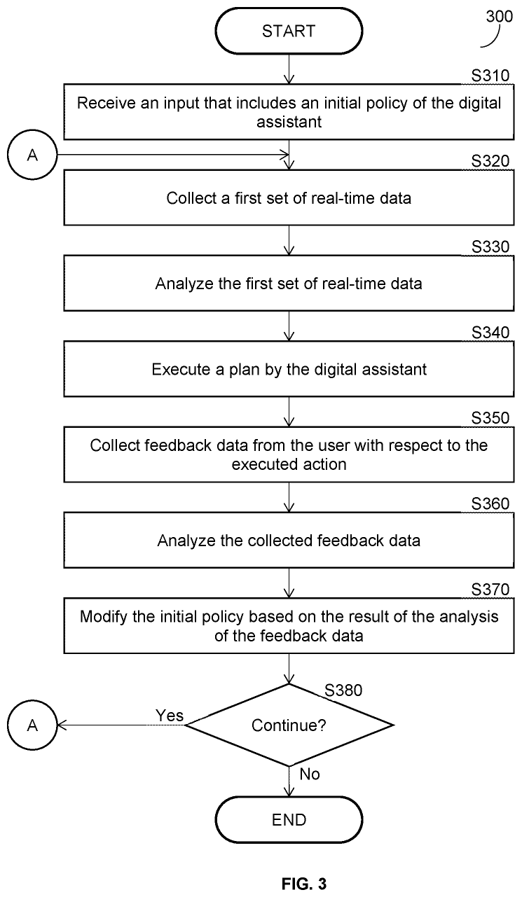

FIG. 3 is an example flowchart 300 illustrating a method for modifying an initial policy of an I/O device 180 of a digital assistant, according to an embodiment. The method described herein may be executed by the controller 130 that is further described hereinabove with respect to FIG. 2.

At S310, an input is received from a user device (e.g., the user device 160). The input includes an initial policy of a digital assistant (e.g., the digital assistant 120). The initial policy facilitates execution of at least one plan by the digital assistant. The initial policy may include a set of initial guidelines that facilitates execution of at least one plan by the digital assistant, as further described hereinabove with respect to FIG. 2.

At S320, a first set of data (e.g., real-time data) is collected with respect to at least the user and the environment near the user. The first set of data may be collected using one or more sensors (e.g., the sensors 140) that are communicatively connected to the digital assistant. The first set of real-time data may be collected using at least a first sensor (e.g., the sensors 140) with respect to the user and an environment in a predetermined proximity to the user. The first set of real-time data is collected in order to determine a current state in proximity to the user. The current state may reflect the state of the user and the state of the environment near the user in real-time, or near real-time. The data that is associated with the user may indicate whether, for example, the user is happy, stressed, angry, sleeping, reading a book, talking on the phone, and the like. The state of the environment refers to the circumstances sensed or otherwise acquired by the digital assistant that are not directly related to the user.

At S330, the first set of data (e.g., the real-time data) is analyzed to determine current state in proximity to the user. The analysis may include applying one or more algorithms, such as a machine learning algorithm, to the first set of data. The algorithm may be adapted to determine the current state. In an embodiment, the collected first set of real-time data may be analyzed using, for example and without limitation, one or more computer vision techniques, audio signal processing techniques, machine learning techniques, or the like.

Further, the analysis at S330 may include generating, based on the data collected at S320, one or more representations of the state of the user, the state of the user's environment, or the like. Such representations may include, as examples, indications that, based on computer vision analysis of sensor video data, the user is within range of a visual sensor, indications that, based on historical data, the user is presently available for interaction, and the like.

As an example, at S320 a picture of the user may be taken, and at S330 such picture is analyzed using an image recognition technique to determine the mental state of the user (e.g., happy or stressed).

In an embodiment, the at least one algorithm includes at least a machine learning algorithm configured to apply a first machine learning model which is trained to determine a current state in proximity to the user. To this end, such a machine learning model is trained using a training data set including training data related to user actions in response to various external stimuli and, more specifically, external stimuli related to outputs caused by the I/O device 180 of the digital assistant (e.g., the digital assistant 120, of FIG. 1).

At S340, a plan (e.g., an action) is executed by the digital assistant (e.g., the digital assistant 120) based on the determined current state in proximity to the user and the initial policy. For example, where analysis of the determined current state indicates that the user is alone at his/her house and that the user has been watching television for more than two hours, the initial policy may include a determination that, when the user has not been active for more than two hours, a plan, such as providing a suggestion to play a cognitive game, should be executed.

At S350, feedback data is collected from a user of the digital assistant with respect to the plan that has been executed by the I/O device 180 of the digital assistant. The feedback data may be collected using one or more sensors that are communicatively connected to the I/O device 180 of the digital assistant.

In an embodiment, at least one feedback data feature is received from the user of the digital assistant with respect to the executed plan. Feedback data feature refers to a reaction or response of the user to a plan performed by the digital assistant, and which may be collected by a sensor. The feedback data may include, for example, a verbal response, a facial expression, gestures made by the user, or the like. For example, a plan that suggests that the user listen to Country music may be executed, and the user may react in a very positive manner. According to the same example, the user's response is sensed (e.g., by the sensors 140) and is collected as feedback data. According to the same example, the feedback data may include identification of a facial expression (e.g., a smile), verbal content (e.g., “yes, this is a great idea!”), and the like.

At S360, the collected at least one feedback data feature is analyzed to determine if the initial policy should be modified. In an embodiment, the analysis may include applying one or more algorithms to the collected at least one feedback data feature. According to an embodiment, the algorithm may be adapted to determine the meaning of the at least one feedback data feature of the user to actions performed by the I/O device 180 of the digital assistant. By determining the meaning of the at least one feedback data feature, user preferences and patterns may be determined. It an embodiment, the at least one feedback data feature, as sensed by the at least a first sensor, may be analyzed in order to determine the meaning of each feedback data feature. According to an embodiment, the analysis of the at least one feedback data feature may be achieved by applying an algorithm adapted to determine the meaning of each feedback data feature. In an embodiment, the analysis of the at least one feedback data feature may include, for example and without limitation, one or more computer vision techniques, audio signal processing techniques, machine learning techniques, and the like.

As an example, when the user shakes his/her head from side to side, it may be determined that this gesture indicates disagreement, and when the user says: “yes, sounds great”, the digital assistant 120 may determine that this reaction is an agreement, and the like.

Further, the analysis of the at least one feedback data feature at S360 may include application of one or more techniques or analyses, including those described hereinabove, to collected feedback data. The applied techniques or analyses may be configured to determine whether the collected feedback data indicates a positive or a negative response. Further, the applied techniques or analyses may be configured to return, for each analyzed feedback data feature, one or more multi-dimensional feedback descriptions.

The applied techniques or analyses may further include one or more machine learning techniques, configured to identify positive or negative reactions within feedback data. Such machine learning techniques, models, or the like, may be supervised or unsupervised. In an embodiment, execution of S360 may include training of one or more second machine learning models, including training machine learning models to identify positive or negative reactions within feedback data.

In an embodiment, the at least one algorithm utilized at S360 includes at least a machine learning algorithm configured to apply a second machine learning model which is trained to identify and determine positive and negative responses based on actions performed by the user of the digital assistance. To this end, such a machine learning model is trained using a training data set including training data related to user actions in response to various external stimuli and, more specifically, external stimuli related to outputs caused by the I/O device 180 of the digital assistant (e.g., the digital assistant 120, FIG. 1).

At S370, the initial policy is modified based on the result of the analysis of the at least one feedback data feature. Modifying the initial policy based on the feedback data that is collected from the user provides for adaptation of the initial policy, and the initial guidelines related thereto, to the user, based on the user's preferences and behavioral patterns, which may be identified and determined using the feedback data. It should be understood that the initial policy is constantly modified based on new feedback data that is collected from the user. Thus, the modified initial policy may be updated through time.

Modification of the initial policy, at S370, may include generating one or more associations between various states and various actions, providing for, for example, identification of various states for which certain actions should always be taken. Further, such modification may include modification of the policy to include a different action for the same state. In addition, such modification may include modification of relationships between existing state-action relationships.

At S380, it is checked whether to continue the execution, and, if so, execution continues with S320; otherwise, execution terminates. Checking whether to continue the execution may include identification of one or more process continuation trigger conditions including, as examples and without limitation, whether a user is present, the run-time of the current process execution, the number of iterations of the current process execution and the like.

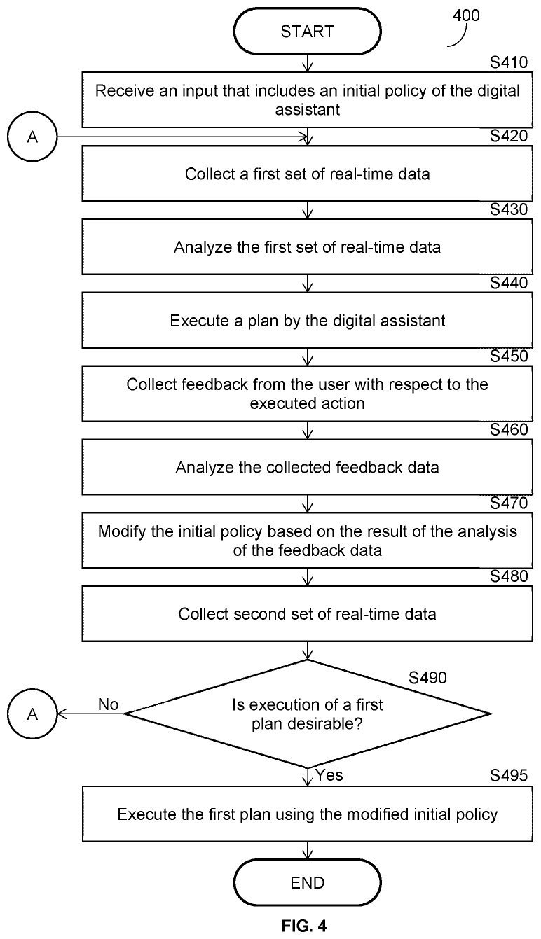

FIG. 4 is an example flowchart 400 illustrating a method for executing a plan by an I/O device of a digital assistant based on a modified initial policy of the I/O device of the digital assistant, according to an embodiment. The method described herein may be executed by the controller 130 that is further described hereinabove with respect to FIG. 2.

At S410, an input is received from a user device (e.g., the user device 160). The input includes an initial policy of a digital assistant (e.g., the digital assistant 120). The initial policy facilitates execution of at least one plan by the digital assistant. The initial policy may include a set of initial guidelines that facilitates execution of at least one plan by the digital assistant as further discussed hereinabove with respect to FIG. 2.

At S420, a first set of data (e.g., real-time data) is collected with respect to at least the user and the environment near the user. The first set of data may be collected using one or more sensors (e.g., the sensors 140). Further, collection at S420 may be similar or identical to collection at S320 of FIG. 3, above.

At S430, the first set of data (e.g., the real-time data) is analyzed to determine current state in proximity to the user. The analysis may include applying one or more algorithms, such as a machine learning algorithm, to the first set of data, as further discussed hereinabove with respect to FIGS. 2 and 3.

In addition, analysis of the first set of data, at S430, may include execution of one or more processes similar or identical to those described with respect to S330 of FIG. 3, above. Further, in an embodiment, S430 and S420 may be executed in parallel, including as a single step.

At S440, a plan is executed by the digital assistant (e.g., the digital assistant 120) based on the result of the analysis of the first set of data, the initial policy, and the determined current state in proximity to the user. Execution, at S440, may be similar or identical to execution as described with respect to S340 of FIG. 3, above.

At S450, feedback data is collected from a user of the digital assistant with respect to the action that has been executed by the digital assistant. The feedback data may be collected using one or more sensors that are communicatively connected to the digital assistant. In addition, collection of feedback data at S450 may be executed in a fashion similar or identical to that of S350 of FIG. 3, above.

At S460, the collected feedback data is analyzed. The analysis may include, for example, applying one or more algorithms to the collected feedback data. According to an embodiment, the algorithm may be adapted to determine the meaning of the feedback data with respect to actions performed by the digital assistant. By determining the meaning of the feedback data, user preferences and patterns may be determined. Analysis of feedback data, at S460, may be conducted in a fashion similar or identical to that described with respect to analysis of feedback data at S360 of FIG. 3, above. Further, in an embodiment, S460 and S450 may be executed in parallel, including as a single step.

At S470, the initial policy is modified based on the result of the analysis of the feedback data. Modifying the initial policy based on the feedback data that is collected from the user provides for adaptation of the initial policy, and the initial guidelines related thereto, to the user, based on the user's preferences and behavioral patterns, which may be identified and determined using the feedback data. Modification of the initial policy, at S470, may include the application of one or more modification processes, techniques, or the like, including those similar or identical to those described with respect to S370 of FIG. 3, above.

At S480, a second set of real-time data is collected after modification of the policy.

The second set of real-time data may be collected using one or more sensors (e.g., the sensors 140). The collection of the second data set may be using sensors different than the sensors utilized for the collection of the first data set of the feedback. It should be noted that the abovementioned at least a first sensor, the at least a second sensor, and the third sensor may be the same sensor (or sensors). The second set of real-time data may be collected with respect to the user, to the environment in a predetermined proximity to the user, or the like. The second set of real-time data may include for example, images, video, audio signals, and the like, as well as any combination thereof. The second set of real-time data may include data that is related to the environment near the first user, such as, as examples and without limitation, the temperature outside the first user's house or vehicle, traffic conditions, and the like. The predetermined proximity may be represented by, for example, a ten meter threshold from the digital assistant 120. As a non-limiting example, the second set of real-time data may indicate, when analyzed, that the user is sitting within a vehicle in which the digital assistant 120 operates, that the user is alone, that the way to a chosen destination will take 23 minutes, and the like. As another non-limiting example, when the digital assistant 120 is configured to operate as a social robot at the user's house, the second set of real-time data may indicate, when analyzed, that the user is standing in the kitchen with another person, who is identified as the user's brother, that the user and the user's brother are in the middle of a conversation, and the like.

At S490, is determined whether execution of a plan by the digital assistant is desirable, and, if so, execution continues with S495; otherwise, execution continues with S420. Determining whether the execution of a plan is desirable may be achieved by analyzing the second set of real-time data and the modified initial policy. The analysis may include applying at least one algorithm to the second set of real-time data and to the modified initial policy. The at least one algorithm may be adapted to determine whether execution of a first plan is desirable.

In an embodiment, the second set of real-time data is analyzed by an application of at least one algorithm, such as a machine learning algorithm, which is adapted to at least determine a current state in a predetermined proximity to the user. That is, the second set of real-time data may be fed into the algorithm, thereby allowing the algorithm to determine the state in proximity to the first user. The collected second set of real-time data may be analyzed using, for example and without limitation, one or more computer vision techniques, audio signal processing techniques, machine learning techniques, and the like. The current state may reflect the state of the user and the state of the environment near the user in real-time, or near real-time. Such a state may be defined in terms of one or more parameters including, as examples and without limitation, the user's level of wakefulness, the user's health condition, the user's mood, whether the user is alone, and the like. Such a state may be generated based on various data features, collected from various sources as described herein, where such generation includes analysis of current sensor data to determine a current state.

The data that is associated with the user may indicate whether, for example, the user is sleeping, reading, stressed, angry, or the like. The state of the environment refers to the circumstances sensed or otherwise acquired by the digital assistant that are not directly related to the user. For example, the current state may indicate that another person is located next to the user, that the user and the other person are located at the user's home, that the identity of the other person is unknown, that it is Sunday morning, that the time is 9:34 AM, and that it is raining outside.

In a further embodiment, whether execution of a plan is desirable (or required) is determined based on the modified policy and the result of the analysis of the second set of real-time data. For example, analysis of the second set of real-time data indicates that the user is alone at his/her house and that the user has been watching television for two hours. According to the same example, although the initial policy includes a rule specifying that when the user has not been active for more than two hours, a plan (e.g., an action) suggesting that the user play a cognitive game, should be executed, the modified initial policy may include a determination that the user likes to watch television every day for three hours in a row. Therefore, only after it is determined that the user has continued to watch television for more than three hours, a suggestion that the user, for example, will play a cognitive game, be executed.

At S495, a plan is executed by the digital assistant (e.g., the digital assistant 120), using the modified initial policy. Execution of the one or more plans may be achieved using one or more resources (e.g., the resources 150). In an embodiment, the plan is executed using the modified initial policy upon determination that execution of the plan is desirable. As a non-limiting example, the real-time data indicates that the user is driving a vehicle that just entered into a parking lot. According to the same example, a plan may be executed using the modified initial policy that suggests that the user will activate the parking assistance system of the vehicle, as it may have been previously determined, based on collected feedback data, that the user becomes stressed when he/she tries to park the vehicle. Executing a plan may be achieved using, the I/O device 180 that may be used for controlling, for example, one or more resources (e.g., the resources 150), such as, a display, speakers, electronic components controlled by the digital assistant 120, and the like. According to another non-limiting example, a social robot (e.g., the electronic device 125), operated by the digital assistant 120, is used by the user to initiate a video call, and the collected second set of real-time data indicates that the volume is set to 3 out of 10 volume levels. According to the same example, based on the modified initial policy, which indicates that the user has hearing problems, a plan which increases the volume to 7 out of 10 volume levels is executed.

It should be noted that the method and processes described herein may be implemented by the controller included in an I/O device 180 and/or the digital assistant.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C, 3A; A and B in combination; B and C in combination; A and C in combination; A, B, and C in combination; 2A and C in combination; A, 3B, and 2C in combination; and the like.

What is claimed is:

1. A computerized method for modifying an initial policy of an input/output device, comprising:
receiving, by an input/output (I/O) device, an input from a user device, wherein the input comprises an initial policy of the I/O device;
collecting, by the I/O device, a first set of real-time data related to an environment in proximity of a user interacting with the I/O device;
applying a first machine learning model on the collected first set of real-time data to determine a current state in proximity to the user;
executing a plan based on the determined current state and the initial policy received from the user device, wherein the initial policy facilitates execution of at least one plan by the I/O device;
collecting, by the I/O device, a feedback data feature with respect to the executed plan, wherein the feedback data feature relates to how the user responds to the executed plan;
applying a second machine learning model on the collected feedback data feature to determine if the initial policy should be modified; and
modifying the initial policy of the I/O device when it is determined that the initial policy should be modified based the collected feedback data feature.

2. The method of claim 1, further comprising:
collecting, by the I/O device, a second set of real-time data, using at least a third sensor that is communicatively connected to the I/O device.

3. The method of claim 2, further comprising:
determining whether execution of a plan is desirable based on the collected second set of real-time data and the modified initial policy.

4. The method of claim 3, further comprising:
executing, by the I/O device, the plan, using the modified initial policy, upon determination that execution of the plan is desirable.

5. The method of claim 1, wherein the initial policy includes a set of initial guidelines that facilitates execution of at least one plan by the I/O device.

6. The method of claim 2, wherein the second set of real-time data is collected with respect to the user and the at least an environment in the proximity of the user.

7. The method of claim 2, wherein the first set of real-time data, the feedback data feature, and the second set of real-time data are collected by different sensors connected to the I/O device.

8. The method of claim 1, wherein the I/O device is integrated in a digital assistant, wherein the digital assistant is at least a social robot.

9. A non-transitory computer readable medium having stored thereon instructions for causing a processing circuitry to execute a process, the process comprising:
receiving, by an input/output (I/O) device, an input from a user device, wherein the input comprises an initial policy of the I/O device;
collecting, by the I/O device, a first set of real-time data related to an environment in proximity of a user interacting with the I/O device;
applying a first machine learning model on the collected first set of real-time data to determine a current state in proximity to the user;
executing a plan based on the determined current state and the initial policy received from the user device, wherein the initial policy facilitates execution of at least one plan by the I/O device;
collecting, by the I/O device, a feedback data feature with respect to the executed plan, wherein the feedback data feature relates to how the user responds to the executed plan;
applying a second machine learning model on the collected feedback data feature to determine if the initial policy should be modified; and
modifying the initial policy of the I/O device when it is determined that the initial policy should be modified based the collected feedback data feature.

10. A system for modifying an initial policy of an input/output device, comprising:
a processing circuitry; and
a memory, the memory containing instructions that, when executed by the processing circuitry, configure the system to:
receive, by an input/output (I/O) device, an input from a user device, wherein the input comprises an initial policy of the I/O device;
collect, by the I/O device, a first set of real-time data related to an environment in proximity of a user interacting with the I/O device;
apply a first machine learning model on the collected first set of real-time data to determine a current state in proximity to the user;
execute a plan based on the determined current state and the initial policy received from the user device, wherein the initial policy facilitates execution of at least one plan by the I/O device;
collect, by the I/O device, a feedback data feature with respect to the executed plan, wherein the feedback data feature relates to how the user responds to the executed plan;
apply a second machine learning model on the collected feedback data feature to determine if the initial policy should be modified; and
modify the initial policy of the I/O device when it is determined that the initial policy should be modified based the collected feedback data feature.

11. The system of claim 10, wherein the system is further configured to:
collect, by the I/O device, a second set of real-time data, using at least a third sensor that is communicatively connected to the I/O device.

12. The system of claim 11, wherein the system is further configured to:
determine whether execution of a plan is desirable based on the collected second set of real-time data and the modified initial policy.

13. The system of claim 12, wherein the system is further configured to:
execute, by the I/O device, the plan, using the modified initial policy, upon determination that execution of the plan is desirable.

14. The system of claim 10, wherein the initial policy includes a set of initial guidelines that facilitates execution of at least one plan by the I/O device.

15. The system of claim 11, wherein the second set of real-time data is collected with respect to the user and the at least an environment in the proximity of the user.

16. The system of claim 11, wherein the first set of real-time data, the feedback data feature, and the second set of real-time data are collected by different sensors connected to the I/O device.

17. The system of claim 11, wherein the I/O device is integrated in a digital assistant, wherein the digital assistant is at least a social robot.
